(19) United States
(12) Patent Application Publication
(10) Pub. No.: US 2019/0028052 A1
(43) Pub. Date: Jan. 24, 2019

(54) EVALUATION APPARATUS FOR EVALUATING INVERTER CIRCUIT FOR ELECTRIC MOTOR AND EVALUATION METHOD THEREFOR

(71) Applicant: KABUSHIKI KAISHA TOSHIBA, Tokyo (JP)

(72) Inventors: Shigen YASUNAKA, Bunkyo Tokyo (JP); Shinji TAKAKURA, Yokohama Kanagawa (JP)

(73) Assignee: KABUSHIKI KAISHA TOSHIBA, Tokyo (JP)

(21) Appl. No.: 15/916,214

(22) Filed: Mar. 8, 2018

(30) Foreign Application Priority Data
Jul. 21, 2017 (JP) 2017-141554

(51) Int. Cl. H02P 29/024; H02P 21/22; H02P 21/18; H02P 27/08

(52) U.S. Cl. CPC H02P 29/024; H02P 21/22; H02M 7/53871; H02P 27/08; H02P 21/18

(57) ABSTRACT

An evaluation apparatus of an embodiment for evaluating an inverter circuit for an electric motor includes a three-phase-to-two-phase converter, a current controller, gate signals generator, and a storage. The three-phase-to-two-phase converter converts primary three-phase currents i₁ᵤ, i₁ᵥ, and i_{1w} of the electric motor connected to the inverter circuit into a d-axis current i_{1d} and a q-axis current i_{1q}. The current controller generates d-axis and q-axis voltage command values v_{1d}* and v_{1q}* for adjusting the q-axis current i_{1q} to a command value i_{1q}* being substantially zero and the d-axis current i_{1d} to a command value i_{1d}* with feedback control of the electric motor through the inverter circuit. The gate signals generator generates gate signals gs based on the command values v_{1d}* and v_{1q}* and applies the gate signals gs to the inverter circuit. The storage stores the command value v_{1d}*.

### CROSS REFERENCE TO RELATED APPLICATION

This application is based upon and claims the benefit of priority from Japanese Patent Application No. 2017-141554, filed on Jul. 21, 2017; the entire contents of which are incorporated herein by reference.

### FIELD

Embodiments described herein relate generally to an evaluation apparatus for evaluating an inverter circuit for an electric motor and an evaluation method therefor.

### BACKGROUND

An electric motor (for example, an induction motor and a synchronous motor) moves heavy objects such as trains, electric vehicles, and elevators. An inverter circuit (main circuit) is used for driving the electric motor at a high voltage and a large current. The inverter circuit applies a PWM-controlled voltage to the electric motor using a power module (a switching device such as MOSEFT and IGBT).

The inverter circuit may fail because of, for example, degradation of its component (such as electrolytic capacitors and power modules). Thus, the degradation of its component is desirably detected before its failure.

The power module switches very fast and this disturbs accurate measurement of its characteristics. For example, a controller with a general microcomputer is used for the measurement, but it has a low sampling frequency due to restrictions on processing speed of the microcomputer.

Moreover, the electric motor has a large back electromotive force with its rotation and a large disturbance on its load during its normal driving, and this disturbs accurate detection of characteristic change in the power module.

However, demounting, inspecting, and remounting the power module take large time and effort, and this causes difficulties in periodic inspection of all power modules in an inverter circuit.

### BRIEF DESCRIPTION OF THE DRAWINGS

FIG. 1 is a block diagram illustrating an inverter evaluation system according to a first embodiment.

FIG. 2 is a circuit diagram illustrating an example of the inverter circuit 20.

FIG. 3 is a flowchart illustrating an example of the operation procedure of the inverter evaluation apparatus 30.

FIG. 4 is a block diagram of the inverter evaluation system according to the second embodiment.

FIG. 5 is a graph illustrating an example of temporal changes in the d-axis current and the q-axis current.

FIG. 6 is a graph illustrating an example of a temporal change in the line current.

FIG. 7 is a graph illustrating an example of temporal change in the angular velocity of the rotor.

FIG. 8 is a graph illustrating an example of the time variation of the d-axis voltage command value v_{1d}*.

FIG. 9 is a graph illustrating an example of the time variation of the d-axis voltage command value v_{1d}*.

FIG. 10 is a graph illustrating an example of the time variation of the d-axis voltage command value v_{1d}*.

### DETAILED DESCRIPTION

An evaluation apparatus of an embodiment for evaluating an inverter circuit for an electric motor includes a three-phase-to-two-phase converter, a current controller, gate signals generator, and a storage. The three-phase-to-two-phase converter converts primary three-phase currents i₁ᵤ, i₁ᵥ, and i_{1w} of the electric motor connected to the inverter circuit into a d-axis current i_{1d} and a q-axis current i_{1q}. The current controller generates d-axis and q-axis voltage command values v_{1d}* and v_{1q}* for adjusting the q-axis current i_{1q} to a command value i_{1q}* being substantially zero and the d-axis current i_{1d} to a command value i_{1d}* with feedback control of the electric motor through the inverter circuit. The gate signals generator generates gate signals gs based on the command values v_{1d}* and v_{1q}* and applies the gate signals gs to the inverter circuit. The storage stores the command value v_{1d}*.

Embodiments will be described in detail with reference to the drawings.

### First Embodiment

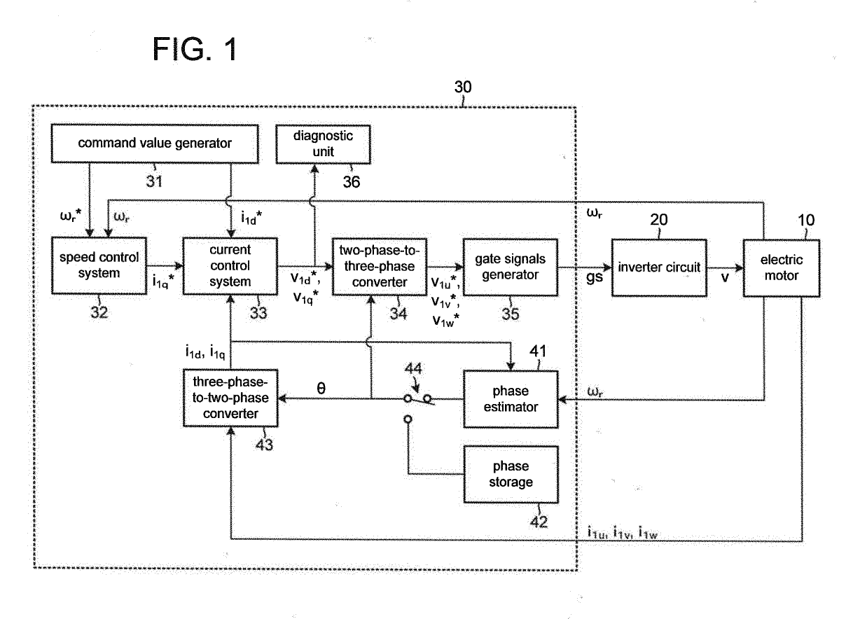

FIG. 1 is a block diagram illustrating an inverter evaluation system according to a first embodiment. The inverter evaluation system includes an electric motor 10, an inverter circuit 20, and an inverter evaluation apparatus 30.

The electric motor 10 is an AC motor operated by a three-phase AC voltage v (v₁ᵤ, v₁ᵥ, v_{1w}) from the inverter circuit 20, and examples of the electric motor 10 include an induction motor and a synchronous motor.

Each of the induction motor and the synchronous motor rotates the rotor with the rotating magnetic flux formed by three-phase alternating current. In a synchronous motor, its rotor is a magnet (permanent magnet or electromagnet). On the other hand, in an induction motor, its rotor is a simple conductor (or a coil).

The electric motor 10 measures and outputs its rotor angular velocity ωᵣ and its current values i₁ᵤ, i₁ᵥ, and i_{1w} of the three phases (u, v, and w phases) on its primary side. The rotor angular velocity ωᵣ and the current values i₁ᵤ, i₁ᵥ, and i_{1w} are input to the inverter evaluation apparatus 30. For example, the rotor angular velocity ωᵣ can be determined by detecting the rotational angle θᵣ of the rotor of the electric motor 10 using a position sensor (for example, encoder) and differentiating the determined the rotational angle θᵣ. The rotor angular velocity ωᵣ may be directly determined using the velocity sensor.

Note, the rotor angular velocity ωᵣ may be estimated without using the position sensor or the velocity sensor. For example, in the synchronous motor, its rotor angular velocity ωᵣ can be estimated from the induced voltage (which is proportional to the rotor angular velocity ωᵣ).

The current values i₁ᵤ, i₁ᵥ, and i_{1w} can be determined using a sense resistor or a current sensor installed in the inverter circuit 20. Note, any two of the current values i₁ᵤ, i₁ᵥ, and i_{1w} may be determined and the remaining one may be obtained from the relationship “i₁ᵤ+i₁ᵥ+i_{1w}=0” where the sum is zero.

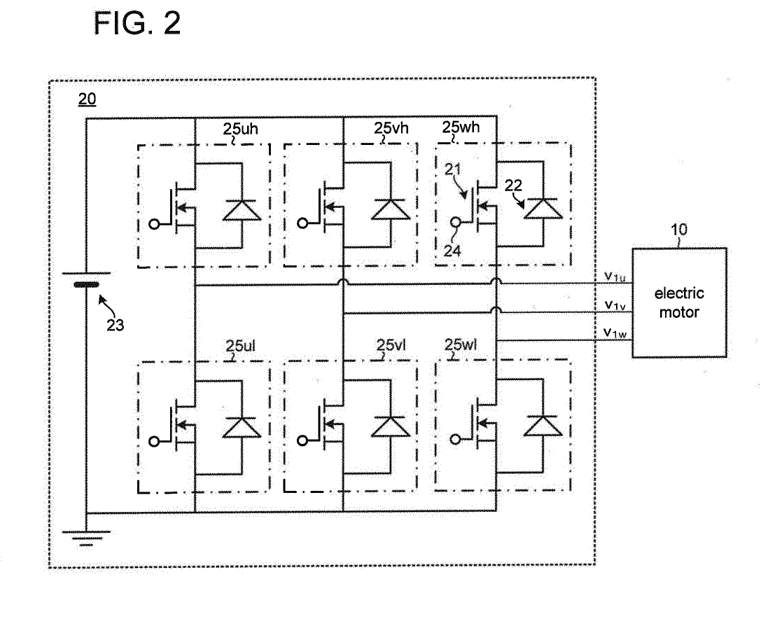

FIG. 2 is a circuit diagram illustrating an example of the inverter circuit 20. The inverter circuit 20 applies the phase voltage v (v₁ᵤ, v₁ᵥ, v_{1w}) of three-phase alternating current generated by Pulse Width Modulation (PWM) to the electric motor 10 to drive it. The inverter circuit 20 has MOSFETs 21, freewheeling diodes 22, and a DC power supply 23.

The MOSFETs 21 are power devices (switching devices). Six MOSFETs 21 (arms 25ul to 25wh) are arranged corresponding to three phases (u, v, and w phases) and high and low (high side, and low side) of voltage (current). Instead of a MOSFET, an IGBT may be used as a power device. The symbols “u”, “v”, and “w” of the arms 25ul to 25wh correspond respectively to the u, v, and w phases, and the symbols “h” and “l” correspond respectively to the high side and the low side of the voltages.

The freewheeling diodes 22 protect the MOSFETs 21 from the reverse current.

Here, one of the MOSFETs 21 and one of the freewheeling diodes 22 constitute one power device unit (arm 25). One arm 25 may include a plurality of MOSFETs 21 and a plurality of freewheeling diodes 22 arranged in parallel to the MOSFETs 21.

The inverter evaluation apparatus 30 (gate signals generator 35) inputs the gate signals gs to a gate driver circuit (not shown) in the inverter circuit 20. The gate driver circuit drives each power device according to the gate signals gs. That is, the gate driver circuit applies a voltage Vgs corresponding to the gate signals gs to between the gate and the source. As a result, the MOSFET 21 is brought into the ON state (reduction in drain-source resistance R_{ds}). In this manner, the MOSFETs 21 are driven according to the gate signals gs to change DC voltage supplied from the DC power supply 23 into voltage pulses having varied pulse width (PWM control). At this time, the electric motor 10 is driven by the generated voltage pulse corresponds to three-phase alternating current.

The inverter evaluation apparatus 30 calculates command values (command values v₁ᵤ*, v₁ᵥ*, and v_{1w}* of the primary voltage input to the gate signals generator 35) in accordance with the primary current values i₁ᵤ, i₁ᵥ, and i_{1w} of the electric motor 10, the rotor angular velocity ωᵣ, the command value ωᵣ* of the rotor angular velocity, and the command value i_{1d}* of the d-axis current output from the command value generator 31, and feedback controls the electric motor 10 (the current values i₁ᵤ, i₁ᵥ, and i_{1w} and the rotor angular velocity ωᵣ).

The inverter evaluation apparatus 30 controls the electric motor 10 using a d-q coordinate system (vector control). The d-axis is the rotation axis of the magnetic flux, and the q-axis is orthogonal to the d-axis. Three-phase currents i₁ᵤ, i₁ᵥ, and i_{1w} are expressed as two-phase currents i_{1d}, and i_{1q} in the d-q coordinate system rotating together with the magnetic flux of the electric motor 10. As a result, the currents i_{1d} and i_{1q} and the voltages v_{1d} and v_{1q} can be treated as if they are direct current quantities.

The circuit equation of the d-q coordinate system of the electric motor 10 is expressed in the equation (1).

$$[ \begin{matrix}{v}_{1 d} \\ {v}_{1 q} \\ {v}_{2 d} \\ {v}_{2 q}\end{matrix} ] = [ \begin{matrix}{R}_{1} + {sL}_{1} & –ω {L}_{1} & sM & - ω M \\ ω {L}_{1} & {R}_{1} + {sL}_{1} & ω M & sM \\ sM & - {ω}_{s} M & {R}_{2} + {sL}_{2} & - {ω}_{s} {L}_{2} \\ {ω}_{s} M & sM & {ω}_{s} {L}_{2} & {R}_{2} + {sL}_{2}\end{matrix} ] [ \begin{matrix}{i}_{1 d} \\ {i}_{1 q} \\ {i}_{2 d} \\ {i}_{2 q}\end{matrix} ] \qquad ( 1 )$$

s: Laplace operator (derivative)

v_{1d}: primary d-axis voltage

v_{1q}: primary q-axis voltage

v_{2d}: secondary d-axis voltage

v_{2q}: secondary q-axis voltage

i_{1d}: primary d-axis current

i_{1q}: primary q-axis current

i_{2d}: secondary d-axis current

i_{2q}: secondary q-axis current

R₁: primary resistance

R₂: secondary resistance

M: mutual inductance

L₁: primary self-inductance (L₁=l₁+M)

L₂: secondary self-inductance (L₂=l₂+M)

l₁: primary leakage inductance

l₂: secondary leakage inductance

Ω: electrical angular velocity

ωₛ: slip angular velocity of induction motor (0 for synchronous motor)

As shown in the equation (1), the voltages v_{1d}, v_{1q}, v_{2d}, and v_{2q} and the currents i_{1d}, i_{1q}, i_{2d}, and i_{2q} in the d-q coordinate system are affected by the electric angular velocity ω (back electromotive force). Therefore, inaccurate electrical angular velocity ω causes difficulty of distinguishing between the characteristic change of the inverter circuit 20 and the influence of the back electromotive force. During normal driving, the influence due to load fluctuations is difficult to be estimated.

However, as described below, the influence due to the back electromotive force and the load fluctuation can be reduced by controlling the electric motor 10 so that the rotational angular velocity ωᵣ of the rotor becomes 0 to adjust the primary q-axis current i_{1q} to 0 (zero)

The torque r applied to the rotor of the electric motor 10 can be expressed by equation (2).

τ=(PₙM/L₂)(i_{1q}φ_{2d}−i_{1d}φ_{2q}) (2)

Pₙ: pole pair number

φ_{2d}: secondary d-axis interlinkage magnetic flux

φ_{2q}: secondary q-axis interlinkage magnetic flux

In the d-q coordinate system, since the d-axis is generally set to the same direction as the secondary magnetic flux, equations (3) and (4) hold.

Φ_{2d}=φ₂ (3)

Φ_{2q}=0 (4)
Φ₂: secondary flux linkage

By applying the equations (3) and (4) to the equation (1), the secondary flux linkage φ₂ is expressed by the following equation (5).

Φ₂=[(R₂M)/(L₂s+R₂)]i_{1d} (5)

Also, the torque r of the rotor is expressed by the equation (6).

τ=(PₙM/L₂)i_{1q}φ₂ (6)

If the primary q-axis current i_{1q} is zero the torque r becomes substantially zero according to the equation (6) and the electric motor 10 does not rotate, even if a secondary interlinkage flux φ₂ exists (i_{1d}≠0).

As described above, by controlling the speed so that the rotational angular velocity ωᵣ of the rotor becomes 0 to adjust the primary q-axis current i_{1q} to 0, the command value v_{1d}* of the d-axis voltage can be obtained without being influenced by the back electromotive force or the load variation.

Characteristics of the power devices (MOSFETs 21) of the inverter circuit 20 can be evaluated by using the command value v_{1d}* of the d-axis voltage. That is, when the characteristics of the power devices (MOSFETs 21) changes, the command value v_{1d}* of the d-axis voltage is considered to change. When the current control system 33 is working, the currents i₁ᵤ, i₁ᵥ, and i_{1w} in the electric motor 10 do not change even if the characteristics of the power devices (inverter circuit 20) change. The command value v_{1d}* is considered to change so as to cancel the characteristic change of the power devices.

When the control is performed as in the embodiment, the electrical angular velocity ω is close to zero, and does not affect the state of the d-axis. Further, the command value i_{1q}* of the q-axis current becomes close to zero, and does not directly relate to the characteristics of the power devices (MOSFETs 21).

The inverter evaluation apparatus 30 includes a command value generator 31, a speed control system 32, a current control system 33, a two-phase-to-three-phase converter 34, gate signals generator 35, a diagnostic unit 36, a phase estimator 41, a phase storage 42, a three-phase-to-two-phase converter 43, and a switch 44.

The command value generator 31 outputs the command value ωᵣ* of the rotor angular velocity and the command value i_{1d}* of the primary d-axis current of the electric motor 10. The command value generator 31 can switch between the normal operation mode and the diagnosis mode. In the normal operation mode, the electric motor 10 is controlled to rotate. On the other hand, in the diagnosis mode, the electric motor 10 is controlled not to rotate. That is, the command value ωᵣ* of the rotor angular velocity is adapted to 0 (zero), and the command value i_{1d}* of the primary d-axis current is set to a predetermined value.

Here, the command value ωᵣ* may be in its vicinity (near zero) even if it is not 0. If the absolute value of the command value ωᵣ* is within a range in which the angular velocity of the rotor can be ignored, it can be said to be near zero. Within this range, it can be said that the electric motor 10 is substantially non-rotating. The command value i_{1d}* can be appropriately changed with time. The details will be described later.

The speed control system 32 feedback controls to generate a command value i_{1q}* for adapting the rotational angular velocity ωᵣ of the electric motor 10 to a command value ωᵣ* in the vicinity of zero. The speed control system 32 receives the rotor angular velocity ωᵣ from the electric motor 10, and the command value ωᵣ* of the rotor angular velocity from the command value generator 31, and outputs the command value i_{1q}* of the primary q-axis current.

As described above, by setting the command value ωᵣ* to 0, the command value i_{1q}* basically converges to 0. However, the command value i_{1q}* may be in its vicinity (near zero) even if it is not 0. If the absolute value of the command value i_{1q}* is within a range in which the angular velocity of the rotor can be ignored, it can be said to be near zero. Within this range, the electric motor 10 can be substantially non-rotated.

The speed control system 32 outputs the command value i_{1q}* of the primary q-axis current according to the difference Δ (=ωᵣ*−ωᵣ) between the rotor angular velocity ωᵣ and the command value ωᵣ*. The speed control system 32 feedback-controls so that the difference Δ approaches zero. For example, the command value i_{1q}* of the primary q-axis current is calculated from the difference Δ using the PI control. That is, the command value i_{1q}* is calculated based on the difference Δ and its integral.

The current control system 33 feedback controls to generate the command values v_{1d}*, and v_{1q}* of the d-axis and q-axis voltages for adjusting the q-axis current i_{1q} to the command value i_{1q}* in the vicinity of zero and the d-axis current i_{1d} to the predetermined command value i_{1d}*. The current control system 33 receives the primary d-axis current value i_{1d} and the primary q-axis current value i_{1q} from the three-phase-to-two-phase converter 43, the command value i_{1d}* of the primary d-axis current from the command value generator 31, and the command value i_{1q}* of the primary q-axis current from the speed control system 32, and outputs the command values v_{1d}* and v_{1q}* of the primary d-axis voltage and the primary q-axis voltage. The current control system 33 can work in non-interference control for suppressing interference between the d-axis and the q-axis.

The currents i_{1d}, and i_{1q} are obtained by converting the three-phase currents i₁ᵤ, i₁ᵥ, and i_{1w} into two-phase currents by the three-phase-to-two-phase converter 43. This details will be described later.

The current control system 33 calculates the command values v_{1d}* and v_{1q}* of the primary d-axis voltage and the primary q-axis voltage in accordance with the difference Δ1 (=i_{1d}*−i_{1d}) between the primary d-axis current i_{1d} and its command value i_{1d}*, and the difference Δ2 (=i_{1q}*−i_{1q}) between the primary q-axis current i_{1q} and the command value i_{1q}*). The current control system 33 feedback controls so that the differences Δ1 and Δ2 both approach zero. For example, the command values v_{1d}* and v_{1q}* are calculated from the differences Δ1 and Δ2 respectively using the PI control. At this time, in addition to the differences Δ1 and Δ2 and their integrals, non-interference control for independently controlling the d-axis and q-axis components can be used.

The two-phase-to-three-phase converter 34 converts the command values v_{1d}*, and v_{1q}* of the two-phase voltage into the command values v₁ᵤ*, v₁ᵥ*, and v_{1w}* of the three-phase voltage. The conversion equations from command values v_{1d}*, and v_{1q}* to command values v₁ᵤ*, v₁ᵥ*, and v_{1w}* are expressed in the equation (7).

$$[ \begin{matrix}{v}_{1 u}^{*} \\ {v}_{1 v}^{*} \\ {v}_{1 w}^{*}\end{matrix} ] = \sqrt{\frac{2}{3}} [ \begin{matrix}cos θ & - sin θ \\ cos ( θ - 2 π \text{/} 3 ) & - sin ( θ - 2 π \text{/} 3 ) \\ cos ( θ + 2 π \text{/} 3 ) & - sin ( θ + 2 π \text{/} 3 )\end{matrix} ] [ \begin{matrix}{v}_{1 d}^{*} \\ {v}_{1 q}^{*}\end{matrix} ] \qquad ( 7 )$$

The two-phase-to-three-phase converter 34 receives the electrical angle θ from the phase estimator 41 or the phase storage 42. The details will be described later.

The gate signals generator 35 generates the gate signals gs based on the command values v_{1d}* and v_{1q}*, and applies them to the inverter circuit 20. Specifically, gate signals gs is generated by comparing the command values v₁ᵤ*, v₁ᵥ*, and v_{1w}* of the three-phase voltages converted from the command values v_{1d}*, and v_{1q}* of the two-phase voltage with the carrier signal (for example, triangular wave or saw-tooth wave).

As described above, the gate signals gs is input to the gate driver circuit (not shown) of the inverter circuit 20. The gate driver circuit drives each power device (gate terminal 24) according to the gate signals gs to apply the voltage v (v₁ᵤ, v₁ᵥ, v_{w1}) to the electric motor 10.

The diagnostic unit 36 stores the command value v_{1d}* of the d-axis voltage and diagnoses the power device (MOSFET 21) of the inverter circuit 20 (evaluates the characteristics) by using the command value v_{1d}*. For example, the command value v_{1d}* of the recorded d-axis voltage is compared with the reference value, and if the absolute value of the difference is larger than the threshold value, the quality of the inverter circuit 20 is determined to degrade. The details will be described later.

The phase estimator 41 estimates the phase (electrical angle θ). As described above, the electrical angle θ is used for conversion in the two-phase-to-three-phase converter 34. The phase estimation method differs depending on the type of the electric motor 10 (induction motor, or synchronous motor).

### A. Estimation of Phase (Electrical Angle θ) in Induction Motor

If the electric motor 10 is an induction motor, the electrical angle θ can be determined using the rotor angular velocity ωᵣ, the primary q-axis current i_{1q}, and the secondary flux linkage φ₂.

The secondary flux linkage flux φ₂, and the slip frequency ωₛ are expressed by the following equations (11) and (12).

φ₂=[M/(1+(L₂/R₂)s)]i_{1d} (11)

ωₛ=(R₂M/L₂Φ₂)i_{1q} (12)

Further, the electrical angular velocity ω of the electric motor 10, the rotor angular velocity ωᵣ, and the slip frequency ωₛ have the relationship of the equation (13).

ω=ωᵣ+ωₛ (13)

The electric angular velocity ea is determined using equations (11) to (13). The electrical angle θ is obtained by integrating the electrical angular velocity ω as follows.

θ=∫ωdt=∫(ωᵣ+ωₛ)dt (14)

### B. Estimation of Phase in Synchronous Motor

If the electric motor 10 is a synchronous electric motor, the electric angle θ can be determined by multiplying the rotational angle θᵣ of the rotor by the pole pair number Pₙ.

θ=Pₙθᵣ (15)

Although an example of a method for estimating the electrical angle θ is described above, other methods may be used.

The phase storage 42 stores a fixed value of the electrical angle θ. The phase storage 42 can store a plurality of fixed values. In the case of an induction motor, the electrical angle θ may be fixed. Setting the electrical angle θ to an appropriate fixed value enables a change in the distribution of the currents (the direction of the current and the ratio of currents in each phase (u, v, and w)) to the arms 25 of the inverter circuit 20. The details will be described later.

The switch 44 switches between the phase estimator 41 and the phase storage.

The three-phase-to-two-phase converter 43 converts the three-phase current i₁ᵤ, i₁ᵥ, and i_{1w} (three-phase currents on the primary of the electric motor 10 connected to the inverter circuit 20) into two-phase currents i_{1d}, and i_{1q} (d-axis current i_{1d}, and q-axis current i_{1q}). The conversion equation from the three-phase currents i₁ᵤ, i₁ᵥ, and i_{1w} to the two-phase currents i_{1d}, and i_{1q} is expressed in Equation (16).

$$[ \begin{matrix}{i}_{1 d} \\ {i}_{1 q}\end{matrix} ] = \sqrt{\frac{2}{3}} [ \begin{matrix}cos θ & cos ( θ - 2 π \text{/} 3 ) & cos ( θ + 2 π \text{/} 3 ) \\ - sin θ & - sin ( θ - 2 π \text{/} 3 ) & - sin ( θ + 2 π \text{/} 3 )\end{matrix} ] [ \begin{matrix}{i}_{1 u} \\ {i}_{1 v} \\ {i}_{1 w}\end{matrix} ] \qquad ( 16 )$$

Hereinafter, the control based on the fixed electrical angle θ will be described. The change in the fixed value varies the direction of the current in the inverter circuit 20 and the ratio of current in each phase. The conversion equation from two-phase current to three-phase current is expressed in equation (17).

$$[ \begin{matrix}{i}_{1 u} \\ {i}_{1 v} \\ {i}_{1 w}\end{matrix} ] = \sqrt{\frac{2}{3}} [ \begin{matrix}cos θ & - sin θ \\ cos ( θ - 2 π \text{/} 3 ) & - sin ( θ - 2 π \text{/} 3 ) \\ cos ( θ + 2 π \text{/} 3 ) & - sin ( θ + 2 π \text{/} 3 )\end{matrix} ] [ \begin{matrix}{i}_{1 d} \\ {i}_{1 q}\end{matrix} ] \qquad ( 17 )$$

As shown in the equation (17), when (the command value of) the currents i_{1d}, and i_{1q} are fixed, the currents i₁ᵤ, i₁ᵥ, and i_{1w} change according to the phase (electrical angle θ). As described above, when the current i_{1q} is 0, the electric motor 10 (rotor) does not rotate. At this time, the electrical angle θ is independent of the rotation of the rotor. That is, the electrical angle θ may be set to an arbitrary value, or it may be changed with time.

For example, when controlling the q-axis current i_{1q} to 0 (q-axis current command value: i_{1q}*=0), the ratio of the currents i₁ᵤ, i₁ᵥ, and i_{1w} changes according to the electrical angle θ (=0, 2π/3, −2π/3 [rad]), as follows.

i₁ᵤ=−2i₁ᵥ=−2i_{1w} (when θ=0 [rad])

−2i₁ᵤ=i₁ᵥ=−2i_{1w} (when θ=2π/3 [rad])

−2i₁ᵤ=−2i₁ᵥ=i_{1w} (when θ=−2π/3 [rad])

That is, even if the command value i_{1d}* of the d-axis current is constant, the ratio of the currents i₁ᵤ, i₁ᵥ, and i_{1w} can be appropriately changed according to the electrical angle θ.

When the currents i_{1d}, i_{1q}, i₁ᵤ, i₁ᵥ, and i_{1w} of the equation (17) are replaced with the voltages v_{1d}*, v_{1q}*, v₁ᵤ*, v₁ᵥ*, and v_{1w}*, respectively, an equation of the voltage holds. That is, even if the command value v_{1d}* of the d-axis voltage is constant, the ratio of the voltages v₁ᵤ*, v₁ᵥ*, and v_{1w}* can be appropriately changed according to the electrical angle θ.

In this way, changing the electrical angle θ can vary where the current flows and the voltage is applied, that is, change the arms 25 (the MOSFET 21) through which the current flows. For example, as described above, setting the electrical angle θ to 0 [rad], 2π/3 [rad], and −2π/3 [rad] increases the contribution of the u-phase high-side arm 25uh, the v-phase high-side arm 25vh, and the w-phase high-side arm 25wh, respectively.

When the electrical angle θ is set to any one of π/6 [rad], π/2 [rad], 7π/6 [rad], −π/6 [rad], −π/2 [rad], and −7π/6 [rad], one of the phase currents i₁ᵤ, i₁ᵥ, and i_{1w} becomes 0. That is, an arm 25 (MOSFET 21) without current flow can be achieved. In this case, the three-phase inverter circuit 20 is driven like a single-phase inverter.

As described above, adjusting the electrical angle θ can limit the arm 25 (the MOSFET 21) through which the current flows. This makes it easy to distinguish the arm 25 (MOSFET 21) whose characteristics has changed.

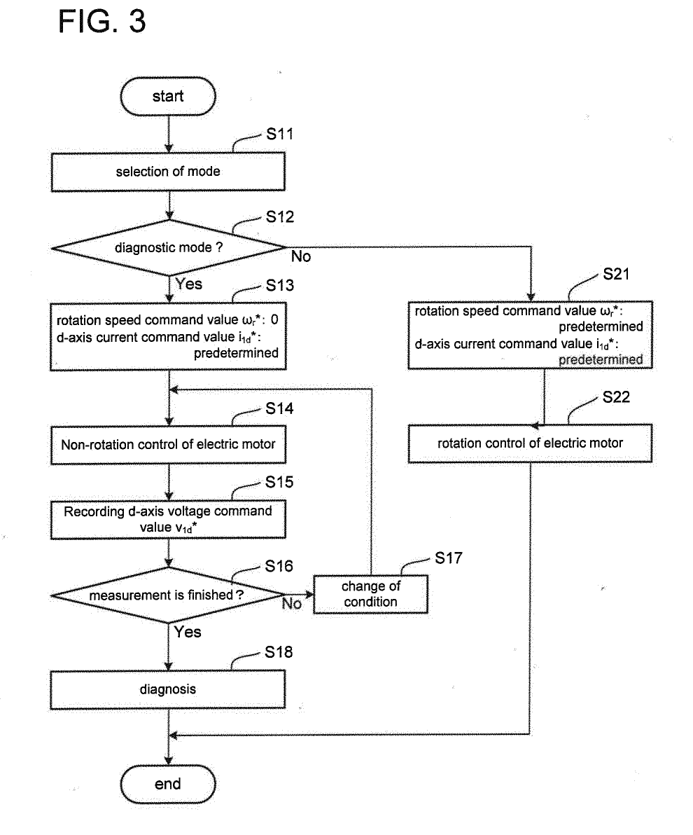

The operation procedure of the inverter evaluation apparatus 30 will be described. FIG. 3 is a flowchart illustrating an example of the operation procedure of the inverter evaluation apparatus 30.

### (1) Selection of Mode (Step S11)

The normal operation mode, or the diagnosis mode are selected. In accordance with the selected mode, the operation of the command value generator 31 is switched. In the normal operation mode, the command value generator 31 outputs normal speed command value (or normal q-axis current command value i_{1q}*) and the d-axis current command value i_{1d}*. In accordance with the gate signals gs outputted from the inverter evaluation apparatus 30, the electric motor 10 rotates (steps S21, and S22).

(2) Outputting the Command Value from the Command Value Generator 31 (Steps S12, and S13)

In the diagnostic mode, the command value generator 31 sets the speed command value ωᵣ* (command value of the rotor angular velocity ωᵣ) to 0 and sets the command value i_{1d}* of the primary d-axis current to a predetermined value.

### (3) Non-Rotation Control of the Electric Motor 10 and Recording (Steps S14, and S15)

As the speed command value ωᵣ* is 0, the inverter evaluation apparatus 30 performs feedback control so that the electric motor 10 is in a non-rotating state, and the command value v_{1d}* of the d-axis voltage is recorded when the control state is stabilized.

(4) Change of Command Value i_{1d}* (Steps S16 and S17)

When the measurement is continued, the command value i_{1d}* is changed, and the non-rotation control and recording is repeated. For example, a step value is added to the command value i_{1d}* (step input), and a command value v_{1d}* of the d-axis voltage is obtained. Instead of step input, DC input or AC input may be used. In accordance with the pattern (step, DC, or AC) of the current i_{1d}, the command value i_{1d}* is changed.

Here, the switch 44 may switch the phase estimator 41 and the phase storage 42. In this case, the electrical angle θ is switched between the estimated value in the phase estimator 41 and the fixed value in the phase storage 42. Further, different electric angles θ may be selected from a plurality of fixed values of the phase storage 42.

### (5) Diagnosis (Step S18)

Upon completion of the measurement, the inverter circuit 20 is diagnosed based on the recorded command value v_{1d}* of the d-axis voltage, and a sign of failure is detected. For example, comparing the command value v_{1d}* of the recorded d-axis voltage with the reference value can determine whether the MOSFET 21 is degraded.

As the reference value, the nominal command value v_{1dn}* and the initial command value v_{1d0}* (initial value) can be used. For example, with respect to a new inverter circuit 20, the command value v_{1d0}* in the initial state is acquired and held, and is compared with the command value v_{1d}* in the inverter circuit 20 after aged degradation. When the current i_{1d} is changed with time, the reference value may be a command value v_{1d}* at a certain time or a value obtained by processing the command values (for example, the average value of the command value v_{1d}*).

Instead of the reference value, the command values v_{1d}* may be compared with each other. For example, the electrical angle θ is adjusted to change phases where current flows through and the command values v_{1d}* between the different phases can be compared with each other. Changes in characteristics between the power devices (arms 25) can be compared.

As described above, feedback controlling the electric motor 10 in a non-rotating state and recording the command value v_{1d}* of the d-axis voltage enable diagnosis of the inverter circuit 20 and detection of a sign of failure.

### Second Embodiment

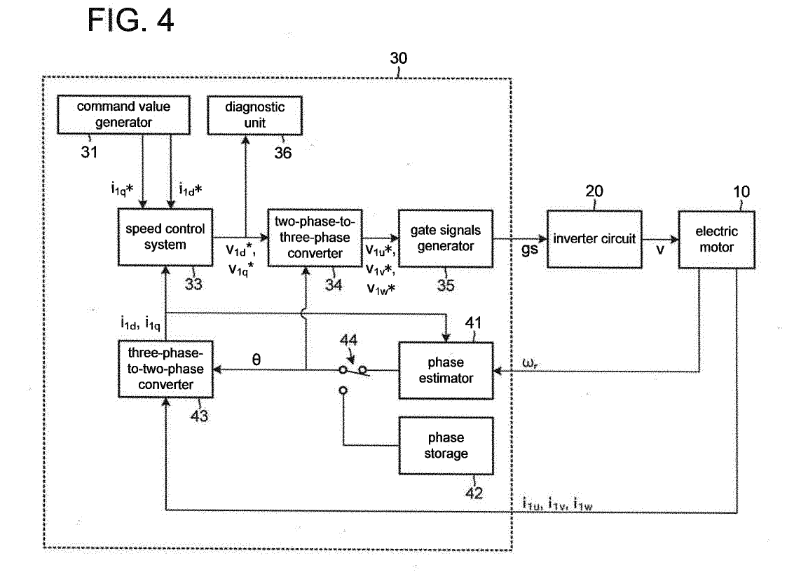

FIG. 4 is a block diagram of the inverter evaluation system according to the second embodiment. This inverter evaluation system does not have the speed control system 32. In this case, the command value generator 31 outputs the command values i_{1q}* and i_{1d}* of the primary q-axis current and the primary d-axis current to the current control system 33.

The command value generator 31 can switch between the normal operation mode and the diagnosis mode. In the normal operation mode, the electric motor 10 is controlled to rotate. On the other hand, in the diagnosis mode, the electric motor 10 is controlled not to rotate. That is, the command value i_{1q}* of the primary q-axis current is 0 (zero), and the command value i_{1d}* of the primary d-axis current is a predetermined value. The command value i_{1d}* can be appropriately changed with time.

As in the first embodiment, the command value i_{1q}* may be in the vicinity (near zero) even if it is not 0. If the absolute value of the command value i_{1q}* is within a negligible range of the angular velocity of the rotor, it can be said to be near zero. Within this range, the electric motor 10 can substantially non-rotate.

As in the first embodiment, the current control system 33 calculates the command values v_{1d}* and v_{1q}* of the primary d-axis voltage and the primary q-axis voltage in accordance with the difference Δ1 (=i_{1d}*−i_{1d}) between the primary d-axis current i_{1d} and its command value i_{1d}*, and the difference Δ2 (=i_{1q}*−i_{1q}) between the primary q-axis current i_{1q} and its command value i_{1q}*. The current control system 33 performs feedback control so that the differences Δ1 and Δ2 both approach zero.

As described above, even in the absence of the speed control system 32, similarly to the first embodiment, feedback controlling the electric motor 10 in a non-rotating state and recording the command value v_{1d}* of the d-axis voltage enable diagnosis of the inverter circuit 20 and detection of a sign of failure.

### EXAMPLE

Hereinafter, the operation result of the inverter evaluation system in the diagnostic mode will be described.

### (1) Example 1

The command value ωᵣ* of the rotor angular velocity is set to 0, the electrical angle θ is set to 0, and the command value i_{1d}* of the current i_{1d} of the d-axis is a value obtained by passing the step input through a low-pass filter.

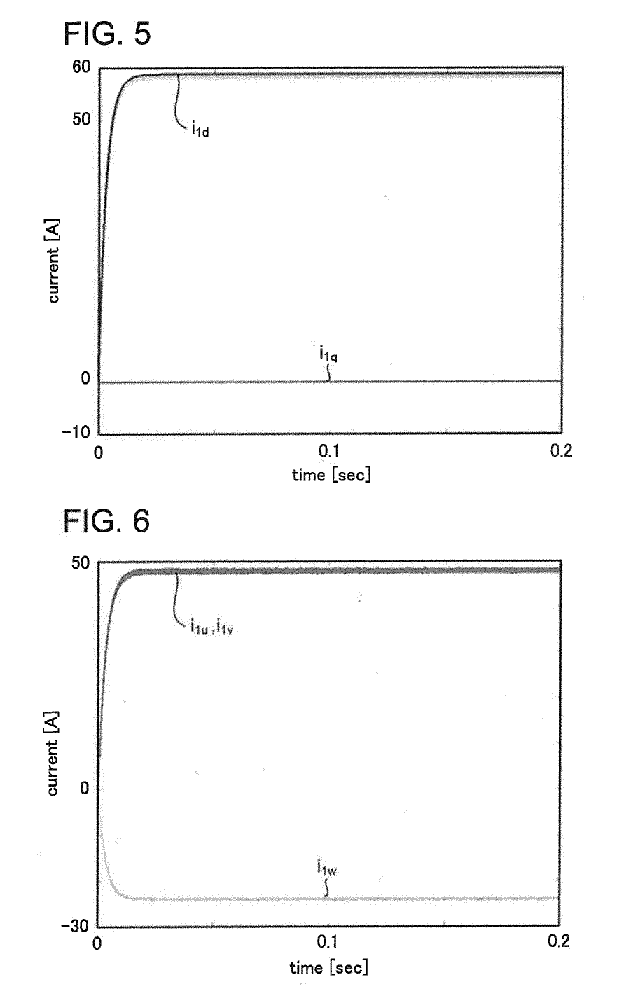

FIGS. 5 to 7 respectively illustrate the temporal changes of (1) the currents i_{1d} and i_{1q} on the d-axis and q-axis, (2) the line currents i₁ᵤ, i₁ᵥ, and i_{1w}, and (3) the rotor angular velocity ωᵣ.

Since the command value i_{1q}* of the q-axis current is 0, the q-axis current i_{1q} is also controlled to be substantially 0. In addition, the current i_{1d} on the d-axis quickly reached substantially a constant value corresponding to the command value i_{1d}* (see FIG. 5).

The line currents i₁ᵤ, i₁ᵤ, and i_{1w} has seemingly the relation “i₁ᵤ=−2i₁ᵥ=−2i_{1w}” corresponding to the electrical angle θ equal to 0 (see FIG. 6).

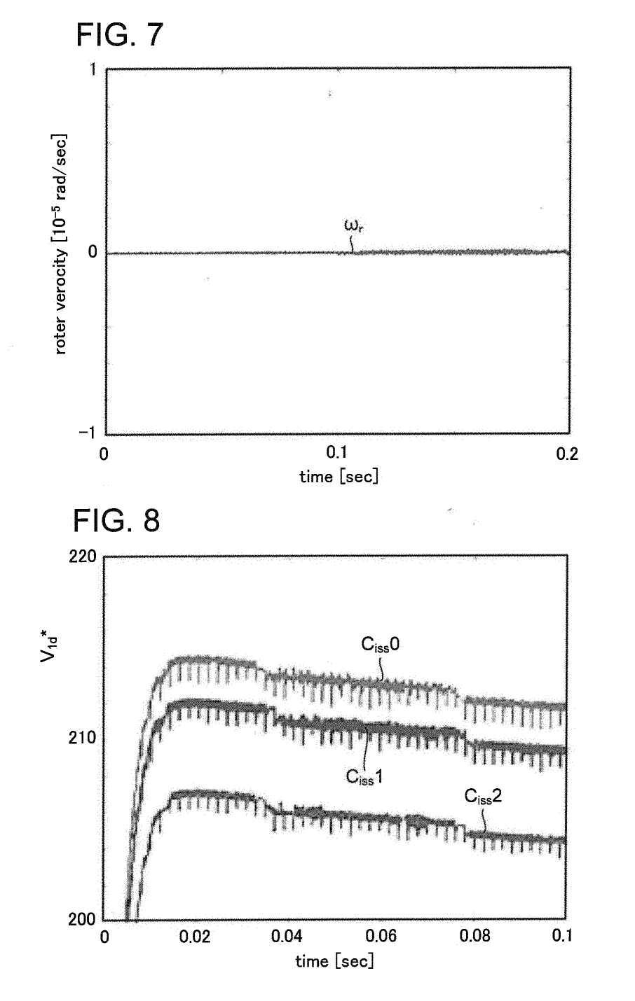

In addition, since no torque is generated, the rotor angular velocity ωᵣ is seemingly extremely small, and the electric motor 10 is not substantially rotated (see FIG. 7).

### (2) Example 2

The input capacitances Cᵢₛₛ of the MOSFETs 21 in the arm 25uh (u-phase high side) are increased from the nominal value Cᵢₛₛ0 to Cᵢₛₛ1, and Cᵢₛₛ2 in two steps, and the command value v_{1d}* of the d-axis voltage is obtained. Note, the command values ωᵣ* and i_{1d}* and the electrical angle θ are the same as in the first embodiment.

FIG. 8 illustrates the temporal change of the command value v_{1d}* of the d-axis voltage. As the input capacitance Cᵢₛₛ increases, the turn-on time increases and the gain of the MOSFET 21 increases. Therefore, the command value v_{1d}* is confirmed to tend to decrease as compared with the case where the command value v_{1d}* is nominal (in the case of the input capacity Cᵢₛₛ0).

### (3) Example 3

The on-resistance R_{dson} of the MOSFET 21 of the u-phase high side (arm 26) is increased from the nominal value R_{dson}0 to R_{dson}1, and R_{dson}2 to obtain the command value v_{1d}* of the d-axis voltage. Note, the command values ωᵣ* and i_{1d}* and the electrical angle θ are the same as in the first embodiment

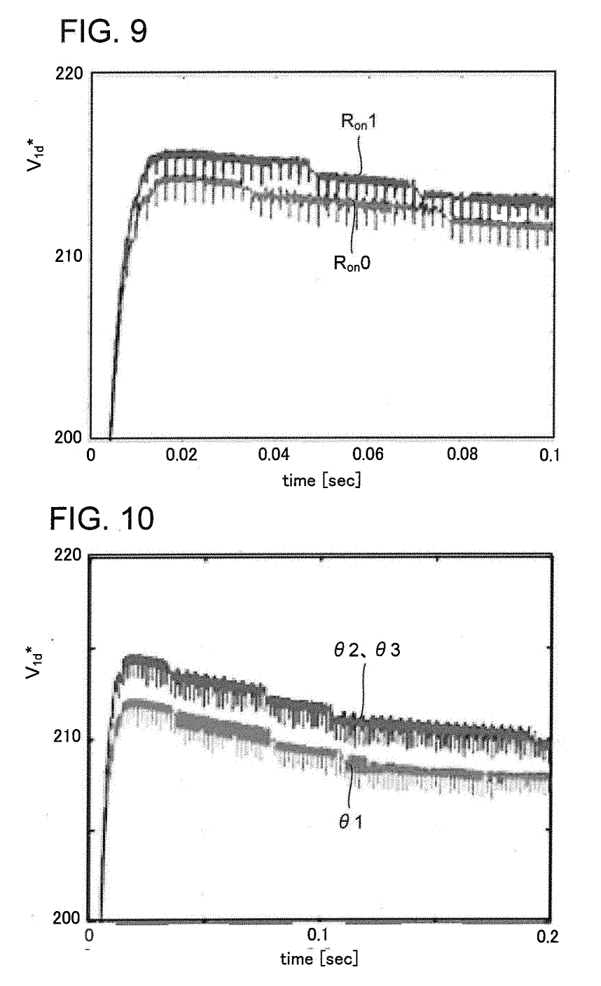

FIG. 9 illustrates the temporal change of the command value v_{1d}* of the d-axis voltage. As the on-resistance R_{dson} increases, the voltage drop increases. Therefore, the gain in the inverter circuit 20 decreases, and the command value v_{1d}* are confirmed to tend to rise as compared with the case where the command value v_{1d}* is nominal (in the case of the on resistance R_{dson}0).

### (4) Example 4

The electrical angle θ is changed into three values θ1, θ2, and θ3 (θ1=0 [rad], θ2=2π/3 [rad], and θ3=−2π/3 [rad]). When the electrical angle θ is θ1, θ2, and θ3, the contribution of the u-phase high-side power device (arm 25uh), v-phase high-side power device (arm 25vh), and w-phase high-side power device (arm 25wh), respectively, becomes large.

The input capacitance Cᵢₛₛ of the u-phase high-side (arm 25uh) MOSFET 21 is set to be large from the nominal value Cᵢₛₛ0, the electrical angle θ is changed to θ1, θ2, and θ3, and the d-axis voltage command value v_{1d}* is obtained in these cases. The command values ωᵣ* and i_{1d}* are the same as those in Example 1.

FIG. 10 illustrates the temporal change of the command value v_{1d}* of the d-axis voltage at this time. When the electrical angle θ is θ1, the command value v_{1d}* of the d-axis voltage is smaller than in the cases that the electrical angle θ is θ2 or θ3. This suggests that the MOSFET 21 of the arm 25uh may be degraded more than the MOSFETs 21 of the arm 25vh and 25wh.

As described above, comparing the control output (the command value v_{1d}* of the d-axis voltage) enables evaluation of the switching characteristics of the power device even with a low sampling frequency.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An evaluation apparatus for evaluating an inverter circuit for a rotation motor, comprising:
a three-phase-to-two-phase converter that converts primary three-phase currents i₁ᵤ, i₁ᵥ, and i_{1w} of the rotation motor connected to the inverter circuit into a d-axis current i_{1d} and a q-axis current i_{1q};
a speed controller that generates a command value i_{1q}* for adjusting rotational angular velocity ωᵣ of the rotation motor to a command value ωᵣ* being substantially zero;
a current controller that generates d-axis and q-axis voltage command values v_{1d}* and v_{1q}* for adjusting the q-axis current i_{1q} to the command value i_{1q}* and the d-axis current i_{1d} to a command value i_{1d}* with feedback control of the rotation motor through the inverter circuit;
gate signals generator that generates gate signals gs based on the command values v_{1d}* and v_{1q}* and applies the gate signals gs to the inverter circuit; and
a storage that stores the command value v_{1d}*.

2. (canceled)

3. The evaluation apparatus according to claim 1, further comprising
a two-phase-to-three-phase converter that converts the command values v_{1d}* and v_{1q}* into three-phase voltage command values v₁ᵤ*, v₁ᵥ*, and v_{1w}*,
wherein the gate signals generator generates the gate signals gs based on the command values v₁ᵤ*, v₁ᵥ*, and v_{1w}*.

4. The evaluation apparatus according to claim 3,
wherein the three-phase-to-two-phase converter and the two-phase-to-three-phase converter perform the conversion based on an electrical angle θ in the rotation motor.

5. The evaluation apparatus according to claim 4,
wherein the electrical angle θ is set to one of π/6, π/2, 7π/6, −π/6, −π/2, and −7π/6.

6. The evaluation apparatus according to claim 4, further comprising
a phase estimator that estimates the electrical angle θ based on the rotor angular velocity ωᵣ of the rotation motor.

7. The evaluation apparatus according to claim 4, further comprising
a diagnosis unit that compares the command value v_{1d}* with a reference value to diagnose the inverter circuit.

8. An evaluation method for evaluating the inverter circuit for a rotation motor, comprising:
converting primary three-phase currents i₁ᵤ, i₁ᵥ, and i_{1w} of the rotation motor connected to the inverter circuit into a d-axis current i_{1d} and a q-axis current i_{1q};
generating a command value i_{1q}* for adjusting rotational angular velocity ωᵣ of the rotation motor to a command value ωᵣ* being substantially zero;
generating d-axis and q-axis voltage command values v_{1d}* and v_{1q}* for adjusting the q-axis current i_{1q} to the command value i_{1q}* and the d-axis current i_{1d} to a command value i_{1d}* with feedback control of the rotation motor through the inverter circuit;
generating gate signals gs based on the command values v_{1d}* and v_{1q}* and applying the gate signals gs to the inverter circuit; and
storing the command value v_{1d}*.

9. An evaluation circuit for evaluating an inverter circuit for a rotation motor, comprising:
a converter that converts an electric current of the rotation motor connected to the inverter circuit;
a control system that generates a command value to adjust the rotational angular velocity of the rotation motor to substantially zero based on the current converted by the converter;
a generator for generating gate signals based on the command value and applying the gate signals to the inverter circuit; and
a storage that stores the command value.
